(19) United States
(12) Patent Application Publication
(10) Pub. No.: US 2021/0346981 A1
(43) Pub. Date: Nov. 11, 2021

(54) TOOL HOLDER

(71) Applicant: NAGOYA INSTITUTE OF TECHNOLOGY, Nagoya-shi, Aichi (JP)

(72) Inventor: Fumihiro Itoigawa, Nagoya-shi, Aichi (JP)

(21) Appl. No.: 17/261,976

(22) PCT Filed: Mar. 15, 2019
(86) PCT No.: PCT/JP2019/010743

§ 371 Date: Jan. 21, 2021

(51) Int. Cl. B23K 26/00

(52) U.S. Cl. CPC B23K 26/0093; H01S 3/1022

(57) ABSTRACT

A tool holder attached to a main spindle of a machine tool is provided. The tool holder includes a main body that has a tubular shape and extends in a direction away from the main spindle with the tool holder attached to the main spindle; an optically pumped laser that is installed inside the main body and configured to radiate a laser light by using an exciting light provided by a light source; an optical system that guides the laser light radiated by the optically pumped laser so that the laser light is emitted from a leading end of the main body in an extending direction of the main body; and a light-guiding path that guides the exciting light from an outside of the main body to the optically pumped laser.

### TECHNICAL FIELD

The present disclosure relates to a tool holder that is attached to a main spindle of a machine tool.

### BACKGROUND ART

A machine tool having a tool holder attached to its main spindle and capable of mechanical machining of a target object with a cutting tool held by the tool holder, and further capable of laser-machining of the target object by laser irradiation is known (see Patent Document 1). A machine tool having two or more main spindles, and a tool holder retaining a tool and attached to each of the main spindles, and processing a target object with the main spindle to place against the target object being switched is also known (see Patent Document 2).

### PRIOR ART DOCUMENTS

### Patent Documents

Patent Document 1: Japanese Unexamined Patent Application Publication No. S59-050983

Patent Document 2: Japanese Unexamined Patent Application Publication No. 2011-240432

### SUMMARY OF THE INVENTION

### Problems to be Solved by the Invention

When laser machining is performed in addition to mechanical machining with a conventional tool, the aforementioned machines require a different configuration for laser machining separate from the main spindle. Thus, alignments and the like for laser machining are additionally required.

More specifically, due to having the different configuration for laser machining, a coordinate system that sets the norm for laser machining is different from a coordinate system for machining the target object via the main spindle. Consequently, when mechanical machining via the main spindle and laser machining by laser irradiation are switched during a processing, an adjustment (alignment) of positional relationship between the machines and the target object is required each time. This renders problems where not only work efficiency decreases but accuracy of machining also tends to decrease due to accumulated errors generated in repeated alignments.

Desirably, the present disclosure improves work efficiency and accuracy of machining when conducting laser machining in addition to mechanical machining with a machine tool.

### Means for Solving the Problems

A tool holder in one aspect of the present disclosure is a tool holder attached to a main spindle of a machine tool, the tool holder including a main body that has a tubular shape and extends in a direction away from the main spindle with the tool holder attached to the main spindle; an optically pumped laser that is installed inside the main body and configured to radiate a laser light by using an exciting light provided by a light source; an optical system that guides the laser light radiated by the optically pumped laser so that the laser light is emitted from a leading end of the main body in an extending direction of the main body; and a light-guiding path that guides the exciting light from an outside of the main body to the optically pumped laser.

In this configuration, the optically pumped laser is installed in the tool holder; and therefore, laser machining can be carried out simply by attaching the tool holder to the already-existing main spindle and causing the exciting light to be incident from the light-guiding path without disposing a different configuration in the machine tool in addition to the main spindle.

As the tool holder itself is attached to the main spindle, the laser light from the optically pumped laser is emitted to a direction specified by a coordinate system of the main spindle. Thus, there is no need to conduct an alignment using a different coordinate system for laser machining. Consequently, when mechanical machining via the main spindle and laser machining using the laser light are switched in a processing, the alignment can still be conducted easily by using the same coordinate system. This absolutely improves work efficiency and also enables inhibition of decrease in accuracy of machining due to alignment.

The optically pumped laser may be of any size installable inside the main body; and specific types of the optically pumped laser are not particularly limited.

For example, the optically pumped laser may be a microchip laser.

The entire configuration of the tool holder can be downsized by using a compact microchip laser for the optically pumped laser.

The light-guiding path may include a translucent path formed of a translucent medium, translucent to a laser light, arranged on an entire area of the translucent path connecting an inside and an outside of the main body along a direction crossing the extending direction of the main body; and a refraction path that refracts the exciting light, guided through the translucent path, inside the main body towards the optically pumped laser.

In this configuration, the exciting light can be incident along a direction along a direction crossing the extending direction of the main body and refracted to reach the optically pumped laser.

The optically pumped laser is arranged so that an axis of the laser light radiated by receiving the exciting light aligns with a center axis of the main body along a direction the tubular shape extends. The main body is arranged so that the center axis of the main body along the direction the tubular shape extends aligns with an axis of the main spindle. The main body includes a rotating body, which is a portion surrounding the center axis for a specified range of length and is rotatable about the center axis independent from other parts of the main body. The light-guiding path includes the translucent path and the refraction path formed in the rotating body. The refraction path refracts the exciting light guided through the translucent path along the center axis of the main body towards the optically pumped laser.

The tool holder is configured to guide the exciting light along the axis of the main spindle to reach the optically pumped laser through the refraction path of the light-guiding path arranged in the rotating body. Thus, if the tool holder itself is rotated about the axis of the main spindle, the exciting light can still be kept appropriately incident on the optically pumped laser through the light-guiding path by rotating the rotating body in a counter direction. Furthermore, the tool holder is configured such that the laser light radiated by the optically pumped laser is directed along the common axis with the main spindle. Thus, if the tool holder itself is rotated about the axis of the main spindle, the laser light radiated by the optically pumped laser can remain to be directed along the axis of the main spindle.

These configurations do not require an alignment in conformity with a rotation of the tool holder when the tool holder itself is rotated, and thus the exciting light can still remain to be appropriately incident on the optically pumped laser through the light-guiding path, and also the laser light radiated by the optically pumped laser can still remain to be directed along the axis of the main spindle.

The light-guiding path may include a translucent path formed of a translucent medium, translucent to a laser light, arranged on an entire area of the translucent path connecting an inside and an outside of the main body along the extending direction of the main body. The light-guiding path may be configured to guide the exciting light guided through the translucent path to the optically pumped laser.

In this configuration, the exciting light can be incident from the tool holder from one end of the translucent path situated by the main spindle to reach the optically pumped laser.

The tool holder may include a light source that emits the exciting light to the optically pumped laser, and an optical fiber that guides the exciting light emitted from the light source to the light-guiding path.

This configuration can cause the exciting light emitted from the light source to be incident on the light-guiding path by using the optical fiber.

### BRIEF DESCRIPTION OF THE DRAWINGS

FIG. 1 is a diagram showing a whole image of a tool holder in the present disclosure.

FIG. 2 is a diagram showing an inner structure of the tool holder in the present disclosure.

FIG. 3 is a diagram showing an inner structure of a tool holder in a different embodiment.

### EXPLANATION OF REFERENCE NUMERALS

1 . . . tool holder, 10 . . . retained portion, 20 . . . main body, 21 . . . rotating body, 30 . . . optically pumped laser, 40 . . . optical system, 41 . . . convergent lenses, 50 . . . light-guiding path, 51 . . . translucent path, 53 . . . refraction path, 55 . . . translucent path, 60 . . . light source, 70 . . . optical fiber.

### MODE FOR CARRYING OUT THE INVENTION

Hereinafter, embodiments of the present disclosure will be described with reference to the drawings.

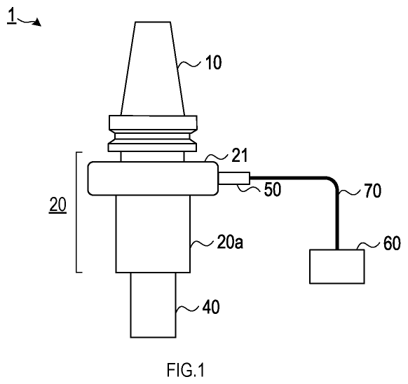

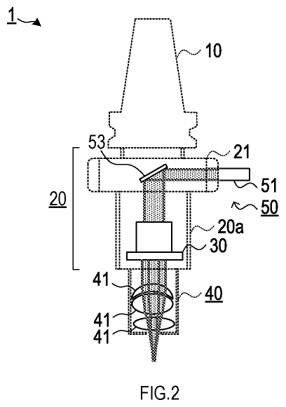

A tool holder 1 is attached to a main spindle of a machine tool, and as shown in FIG. 1 and FIG. 2, the tool holder 1 includes a retained portion 10 retained by the machine tool at the main spindle; a tubular main body 20 extending from the retained portion 10; an optically pumped laser 30 installed inside the main body 20; an optical system 40 for guiding a laser light radiated by the optically pumped laser 30 to be emitted from a leading end of the main body 20; a light-guiding path 50 for guiding an exciting light from an outside of the main body 20 to the optically pumped laser 30; a light source 60 for emitting an exciting light that is suitable for the optically pumped laser 30; and an optical fiber 70 for guiding the exciting light emitted from the light source 60 to the light-guiding path 50.

The retained portion 10 is formed into a shape of a truncated cone with its diameter decreasing towards a first end of the retained portion 10 (upper end in FIG. 1 and FIG. 2). This first end is retained in a depression (not shown) formed on the main spindle of the machine tool, and thereby the tool holder 1 is attached to the main spindle of the machine tool. This truncated cone of the retained portion 10 is formed so that a center axis of the truncated cone along its height aligns with an axis of the main spindle that is a rotational center of the main spindle.

With the tool holder. 1 attached to the main spindle, the main body 20 extends to form a tubular shape in a direction away from the main spindle, in other words, in a direction away from a second end of the retained portion 10 (lower end in FIG. 1 and FIG. 2). This main body 20 is arranged so that a center axis of the main body 20 along the direction the tubular shape extends aligns with the axis of the main spindle. The main body 20 includes a rotating body 21, which is a portion surrounding the center axis of the main body for a specified range of length and is rotatable about the center axis of the main body independent from other parts of the main body 20.

The optically pumped laser 30 is installed inside a tubular portion 20a of the main body 20 and radiates the laser light using the exciting light provided by the light source 60. The optically pumped laser 30 may be of any size installable inside the main body 20, and specific types of the optically pumped laser 30 are not particularly limited. A microchip laser is adopted in the present embodiment.

The optically pumped laser 30 is arranged so that an axis of the laser light radiated by the optically pumped laser 30 by receiving the exciting light aligns with the center axis of the main body 20 along the direction the tubular shape extends.

The optical system 40 guides the laser light radiated by the optically pumped laser 30 so that the laser light is emitted from the leading end of the main body 20 in an extending direction of the main body 20. More specifically, the optical system 40 includes one or more convergent lenses 41 that converge the laser light radiated by the optically pumped laser 30 and cause the converged light to be emitted from the leading end of the main body 20.

In the present embodiment, the convergent lenses 41 are arranged so that the laser light from the optically pumped laser 30 is converged with the axis of the laser light unchanged. The laser light is thus emitted with its axis aligned with the center axis of the main body 20.

The light-guiding path 50 includes a translucent path 51 formed of a translucent medium, translucent to the laser light, arranged on an entire area of the translucent path 51 in an inside and the outside of the main body 20 along a direction crossing the extending direction of the main body 20; and a refraction path 53 that refracts the exciting light, guided through the translucent path 51, inside the main body 20 towards the optically pumped laser 30. The translucent path 51 and the refraction path 53 are fixed to the rotating body 21 of the main body 20 and thereby configured to rotate in accordance with the rotation of the rotating body 21.

The translucent path 51 of the light-guiding path 50 is a pathway formed by arranging the translucent medium translucent to the laser light on its entire area connecting the inside and the outside of the main body 20, and thereby allowing the exciting light to pass through the main body 20 to and from the inside and the outside of the main body 20. More specifically, the translucent path 51 may be a hole that penetrates the main body 20 along a direction connecting the inside and the outside of the main body 20. Alternatively, the translucent path 51 may be formed by arranging a member translucent to the light on its entire area in the inside and the outside of the main body 20. In a case a hole penetrating the main body 20 along the direction connecting the inside and the outside of the main body 20 is formed, a gas present inside the hole serves as the translucent medium translucent to the laser light.

The refraction path 53 is a mirror arranged at a location where a direction of emission of the exciting light guided through the translucent path 51 crosses a direction of incidence of the exciting light to the optically pumped laser 30. This mirror refracts the exciting light guided through the translucent path 51 towards the optically pumped laser 30.

One embodiment of the present disclosure has been explained. Nevertheless, it should be noted that the present disclosure is not limited to the aforementioned embodiment but may be embodied in various other forms within the technical scope of the present disclosure.

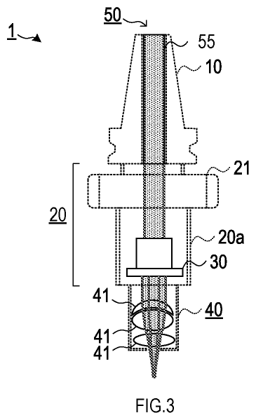

For example, in the aforementioned embodiment, the light-guiding path 50 includes the translucent path 51 and the refraction path 53. Nevertheless, a specific configuration of the light-guiding path 50 is not particularly limited as long as the exciting light can be guided to the optically pumped laser 30. For example, as shown in FIG. 3, the light-guiding path 50 may include a translucent path 55 formed of a translucent medium, translucent to a light, arranged from an outside to an inside of an end of the retained portion 10 and a translucent medium, translucent to a light, arranged from the outside to the inside of an end of the main body 20; and the exciting light guided through this translucent path 55 may be guided to the optically pumped laser 30.

The aforementioned embodiment exhibited an example in which the laser light is emitted such that the axis of the emitted laser light aligns with the center axis of the main body 20. Nevertheless, the laser light may be emitted with its axis unaligned with the center axis of the main body 20. For example, the laser light may pass through a pair of wedge prisms to displace the axis.

In the aforementioned embodiment, the optically pumped laser 30 is installed in the tool holder 1; and therefore, laser machining can be carried out simply by attaching the tool holder 1 to the already-existing main spindle and causing the exciting light to be incident from the light-guiding path 50 without disposing a different configuration in the machine tool in addition to the main spindle.

As the tool holder 1 itself is attached to the main spindle, the laser light from the optically pumped laser 30 is emitted to a direction specified by a coordinate system of the main spindle. Thus, there is no need to conduct an alignment using a different coordinate system for laser machining. Consequently, when mechanical machining via the main spindle and laser machining using the laser light are switched in a processing, the alignment can still be conducted easily by using the same coordinate system. This absolutely improves work efficiency and also enables inhibition of decrease in accuracy of machining due to alignment.

In the aforementioned embodiment, the entire configuration of the tool holder 1 can be downsized by using a compact microchip laser for the optically pumped laser 30.

In the aforementioned embodiment, the exciting light can be incident through the light-guiding path 50 along a direction crossing the extending direction of the main body 20 and refracted to reach the optically pumped laser 30.

In the aforementioned embodiment, the tool holder 1 is configured to guide the exciting light along the axis of the main spindle to reach the optically pumped laser 30 through the refraction path 53 of the light-guiding path 50 arranged in the rotating body 21. Thus, if the tool holder 1 itself is rotated about the axis of the main spindle, the exciting light can still be kept appropriately incident on the optically pumped laser 30 through the light-guiding path 50 by rotating the rotating body 21 in a counter direction.

Furthermore, the tool holder 1 is configured such that the laser light radiated by the optically pumped laser 30 is directed along the common axis with the main spindle. Thus, if the tool holder 1 itself is rotated about the axis of the main spindle, the laser light radiated by the optically pumped laser 30 can remain to be directed along the axis of the main spindle.

As described above, the aforementioned embodiment does not require an alignment in conformity with a rotation of the tool holder 1 when the tool holder 1 itself is rotated, and thus the exciting light can still remain to be appropriately incident on the optically pumped laser 30 through the light-guiding path 50, and also the laser light radiated by the optically pumped laser can still remain to be directed along the axis of the main spindle.

The aforementioned embodiment can also cause the exciting light emitted from the light source 60 to be incident on the light-guided path 50 by using the optical fiber 70.

If the light-guiding path 50 includes the translucent path 55 arranged from the end of the retained portion 10 and the end of the main body 20, the exciting light can be incident from the tool holder 1 from one end of the translucent path 55 situated by the main spindle to reach the optically pumped laser 30.

1. A tool holder attached to a main spindle of a machine tool, the tool holder comprising:
a main body that has a tubular shape and extends in a direction away from the main spindle with the tool holder attached to the main spindle;
an optically pumped laser that is installed inside the main body and configured to radiate a laser light by using an exciting light provided by a light source;
an optical system that guides the laser light radiated by the optically pumped laser so that the laser light is emitted from a leading end of the main body in an extending direction of the main body; and
a light-guiding path that guides the exciting light from an outside of the main body to the optically pumped laser.

2. The tool holder according to claim 1, wherein the optically pumped laser is a microchip laser.

3. The tool holder according to claim 1,
wherein the light-guiding path includes a translucent path formed of a translucent medium that is translucent to the laser light, arranged on an entire area of the translucent path connecting an inside and an outside of the main body along a direction crossing the extending direction of the main body; and includes a refraction path that refracts the exciting light, guided through the translucent path, inside the main body towards the optically pumped laser.

4. The tool holder according to claim 3,
wherein the optically pumped laser is arranged so that an axis of the laser light radiated by receiving the exciting light aligns with a center axis of the main body along a direction the tubular shape extends,
wherein the main body is arranged so that the center axis of the main body along the direction the tubular shape extends aligns with an axis of the main spindle,
wherein the main body includes a rotating body, which is a portion surrounding the center axis for a specified range of length and is rotatable about the center axis independent from other parts of the main body,
wherein the light-guiding path includes the translucent path and the refraction path formed in the rotating body, and
wherein the refraction path refracts the exciting light guided through the translucent path along the center axis of the main body towards the optically pumped laser.

5. The tool holder according to claim 1,
wherein the light-guiding path includes a translucent path formed of a translucent medium that is translucent to the a laser light, arranged on an entire area of the translucent path connecting an inside and an outside of the main body along the extending direction of the main body, and
wherein the light-guiding path is configured to guide the exciting light guided through the translucent path to the optically pumped laser.

6. The tool holder according to claim 1, comprising:
a light source that emits the exciting light to the optically pumped laser, and
an optical fiber that guides the exciting light emitted from the light source to the light-guiding path.
